(19) United States
(12) Patent Application Publication
(10) Pub. No.: US 2022/0032833 A1
(43) Pub. Date: Feb. 3, 2022

(54) Ground To Vehicle Loading Device

(71) Applicant: William Richardson, Bessemer, AL (US)

(72) Inventor: William Richardson, Bessemer, AL (US)

(21) Appl. No.: 16/943,316

(22) Filed: Jul. 30, 2020

(51) Int. Cl. B60P 1/34; B60P 1/64

(52) U.S. Cl. CPC B60P 1/34; B60P 1/6409

(57) ABSTRACT

A ground to vehicle loading device for loading cargo on a vehicle includes a frame that is pivotally mountable by a first end to a vehicle adjacent to a cargo area thereof. The frame is selectively pivotable from a first configuration to a second configuration. In the first configuration, the frame extends transversely from the cargo area to a surface upon and positioned for loading. In the second configuration, the frame is substantially horizontally and positioned to transfer the load to the cargo area. A leg is pivotally coupled to the frame proximate to a second end of the frame. A plurality of spikes is coupled to and extends from the leg distal from the frame. The spikes engage the surface to transition the frame from the first configuration to the second configuration as the vehicle pulls on the first end of the frame.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to loading devices and more particularly pertains to a new loading device for loading cargo on a vehicle.

### (2) Description of Related Art Including Information Disclosed Under 37 CFR 1.97 and 1.98

The prior art relates to loading devices. Prior art devices may comprise a fixed frame with a pair of pivoting legs, which have lower ends that engage the ground or are anchored by attachment to the wheels of the vehicle. Other prior art devices may comprise a frame and a tether, with the tether being either coupled to an immovable object or pulled by hand to lift the frame. Still other devices may comprise a frame and a winch. Still other devices may comprise a telescoping frame with a single leg pivotally attached thereto, and with the single leg being footed.

### BRIEF SUMMARY OF THE INVENTION

An embodiment of the disclosure meets the needs presented above by generally comprising a frame that is configured to be pivotally mountable by a first end to a vehicle adjacent to a cargo area of the vehicle. The frame is selectively pivotable from a first configuration to a second configuration. In the first configuration, the frame extends transversely from the cargo area to a surface upon which the vehicle is positioned and is configured to position a load. In the second configuration, the frame is substantially horizontal to the surface and is configured to transfer the load to the cargo area. A leg is pivotally coupled by a first terminus to the frame proximate to a second end of the frame. A plurality of spikes is coupled to and extends from a second terminus of the leg and is configured to engage the surface to transition the frame from the first configuration to the second configuration as the vehicle pulls on the first end of the frame.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a ground to vehicle loading device according to an embodiment of the disclosure.

FIG. 2 is a back view of an embodiment of the disclosure.

FIG. 3 is a front view of an embodiment of the disclosure.

FIG. 4 is a detail view of an embodiment of the disclosure.

FIG. 5 is a detail view of an embodiment of the disclosure.

FIG. 6 is an in-use view of an embodiment of the disclosure.

FIG. 7 is an in-use view of an embodiment of the disclosure.

FIG. 8 is an in-use view of an embodiment of the disclosure.

FIG. 9 is an in-use view of an embodiment of the disclosure.

### DETAILED DESCRIPTION OF THE INVENTION

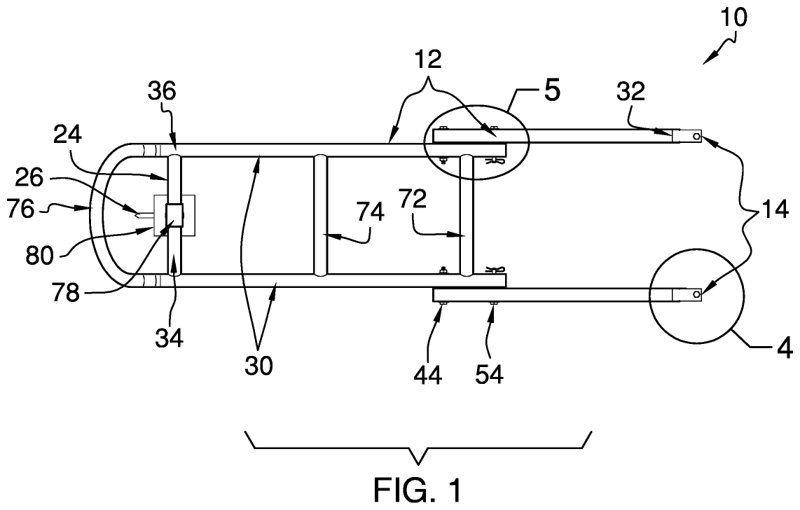

With reference now to the drawings, and in particular to FIGS. 1 through 9 thereof, a new loading device embodying the principles and concepts of an embodiment of the disclosure and generally designated by the reference numeral 10 will be described.

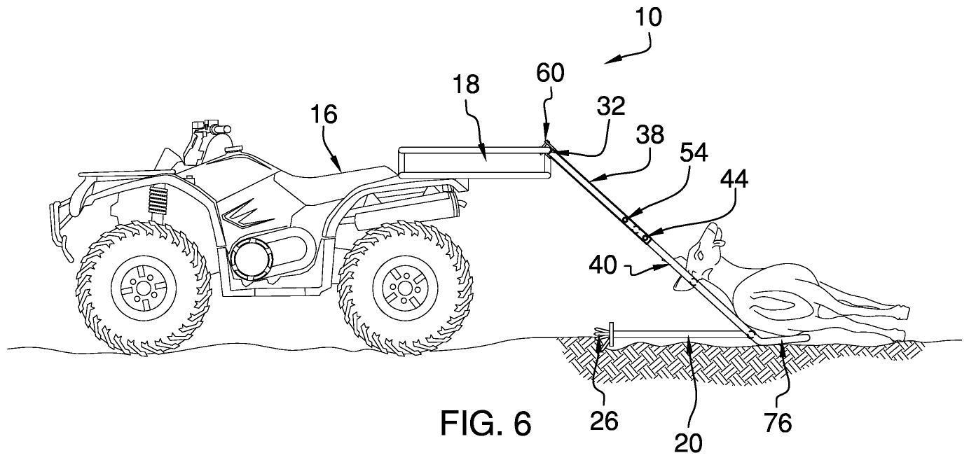

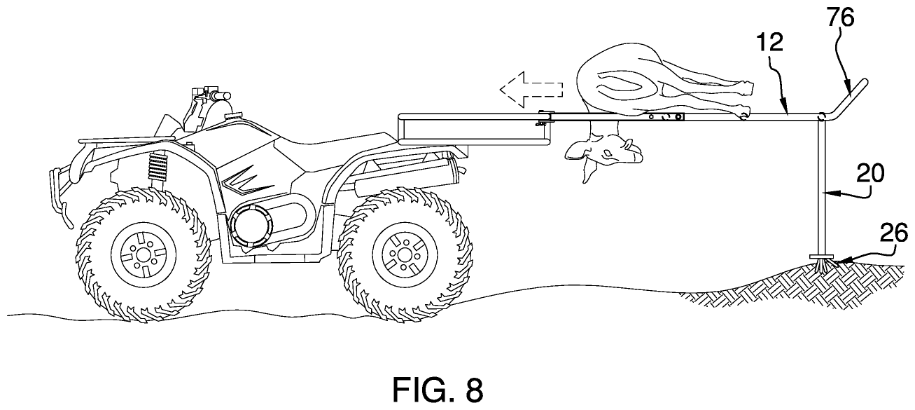

As best illustrated in FIGS. 1 through 9, the ground to vehicle loading device 10 generally comprises a frame 12 that is configured to be pivotally mountable by a first end 14 to a vehicle 16, such as an all-terrain vehicle, adjacent to a cargo area 18 of the vehicle 16. The frame 12 is selectively pivotable from a first configuration to a second configuration. In the first configuration, the frame 12 extends transversely from the cargo area 18 to a surface upon which the vehicle 16 is positioned, as shown in FIG. 6, and is configured to position a load, such as a deer, a bale of hay or straw, a bag of seed, or the like. In the second configuration, the frame 12 is substantially horizontal to the surface, as shown in FIG. 8, and is configured to transfer the load to the cargo area 18.

A leg 20 is pivotally coupled by a first terminus 22 to the frame 12 proximate to a second end 24 of the frame 12. As will become apparent, the present invention anticipates the leg 20 having a length complementary to a height of the cargo area 18 above the surface to facilitate transfer of the load to the cargo area 18. The leg 20 may comprise a plurality of nested sections 26, as shown in FIG. 3, so that the leg 20 is selectively extensible and thus selectively length adjustable.

A plurality of spikes 26 is coupled to and extends from a second terminus 28 of the leg 20 and is configured to engage the surface to transition the frame 12 from the first configuration to the second configuration as the vehicle 16 pulls on the first end 14 of the frame 12. With the frame 12 positioned in the second configuration, a user is positioned to slide the load from the frame 12 to the cargo area 18 of the vehicle 16. While the device 10 is anticipated to be of particular use to a hunter in loading a large game animal, such as a deer, onto a cargo rack of an all-terrain vehicle, it also would be useful in loading bales, bags, sacks, bundles, and the like.

The frame 12 comprises a pair of first rods 30, each of which has a first endpoint 32 that is configured to be pivotally coupled to the vehicle 16. A second rod 34 is coupled to and extends between the first rods 30 proximate to second endpoints 36 of the first rods 30. Each first rod 30 comprises a first section 38 that is pivotally engaged to a second section 40. The first section 38 and the second section 40 are selectively pivotable to a folded configuration wherein the first end 14 of the frame 12 is positioned proximate to the second end 24 of the frame 12. The folded configuration allows for easy transport of the frame 12. The second section 40 is selectively and fixedly couplable to the first section 38 to fixedly position the frame 12 in a planar configuration.

The first section 38 and the second section 40 are partially overlapping, as shown in FIG. 5. The first section 38 and the second section 40 each have a pivot hole 42 positioned therethrough so that the pivot holes 42 are aligned. A pivot fastener 44 is inserted through the pivot holes 42 to pivotally connect the first section 38 to the second section 40. The pivot fastener 44 may comprise a pivot bolt 46, a washer 48, and a locking nut 50, as shown in FIG. 5, or other fastening means, such as, but not limited to, double headed bolts, rivets, and the like.

The first section 38 and the second section 40 each have a locking hole 52 positioned therethrough so that the locking holes 52 are selectively alignable. A locking fastener 54 is selectively insertable through the locking holes 52 to fixedly position the frame 12 in the planar configuration. The locking fastener 54 may comprise a locking bolt 56 and a locking cotter 58, as shown in FIG. 5, or other fastening means, such as, but not limited to, thumbscrews, quick release fasteners, and the like.

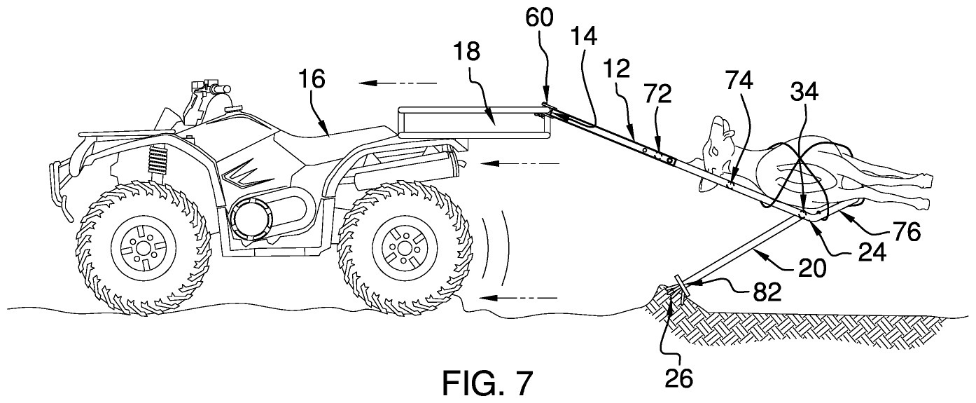

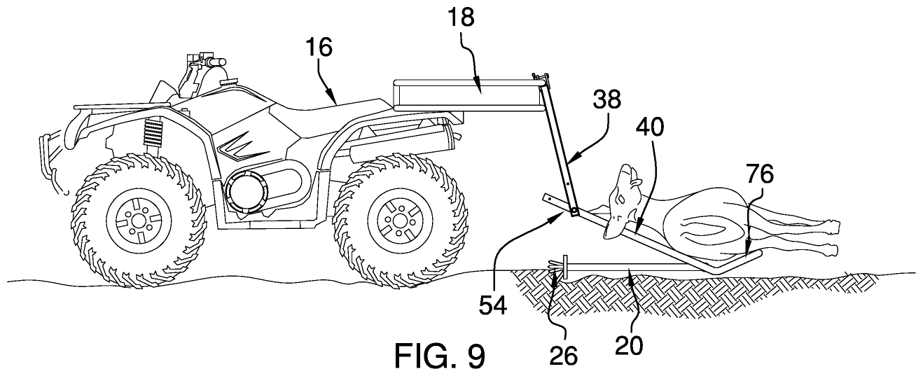

The pivoting relationship of the second section 40 relative to the first section 38 enables the user to position the second section 40 proximate to the surface, as shown in FIG. 9, to facilitate positioning of the load upon the frame 12. The vehicle 16 then can be engaged to pull the frame 12 to an intermediate position, as shown in FIG. 7, wherein the locking holes 52 are aligned and positioned for insertion of the locking fastener 54.

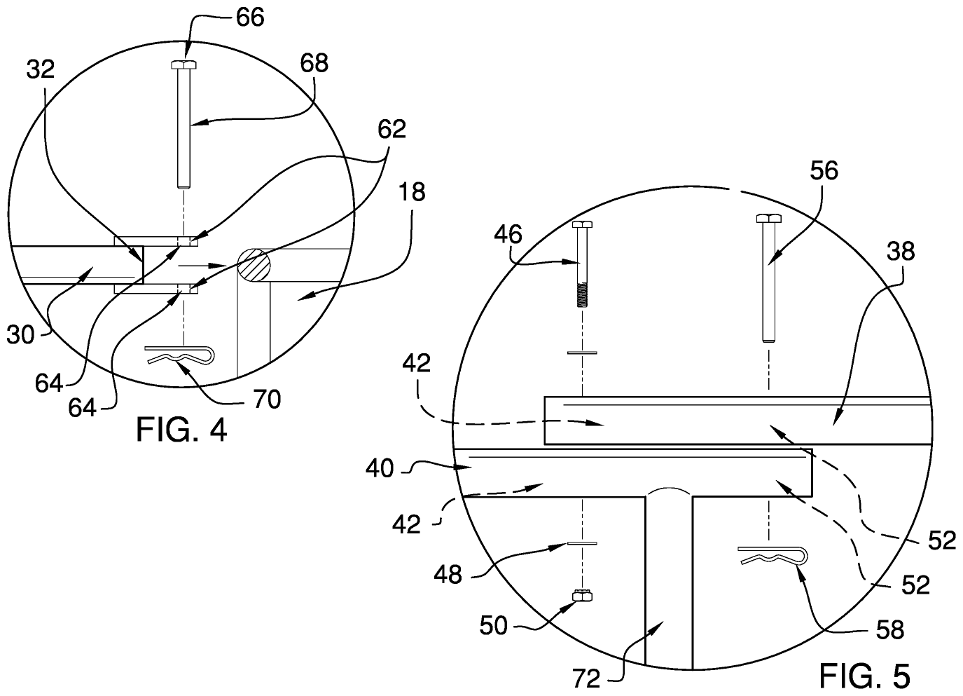

Each of a pair of connectors 60 is engaged to the first endpoint 32 of a respective first rod 30, as shown in FIG. 4. The connectors 60 are configured to reversibly engage a bar of a cargo rack of the vehicle 16 to removably and pivotally mount the frame 12 to the vehicle 16.

Each connector 60 may comprise a pair of tabs 62, each of which has a connecting hole 64 positioned therethrough. The connecting holes 64 are positioned for insertion of a connecting fastener 66 to pivotally connect the respective first rod 30 to the bar of the cargo rack. The present invention anticipates the connector 60 comprising other pivotable connecting means, such as, but not limited to, interlocking half rings, pivot ball connections, and the like. The connecting fastener 66 may comprise a connecting bolt 68 and a connecting cotter 70, as shown in FIG. 4, or other fastening means, such as, but not limited to, double headed bolts, rivets, and the like.

The device 10 may comprise a third rod 72 that is coupled to and extends between the second sections 40 to rigidify the frame 12. The third rod 72 is positioned between the pivot holes 42 and the locking holes 52. The device 10 also may comprise a fourth rod 74 that is coupled to and extends between the second sections 40 to rigidify the frame 12. The fourth rod 74 is positioned substantially equally distant from the second rod 34 and the pivot holes 42.

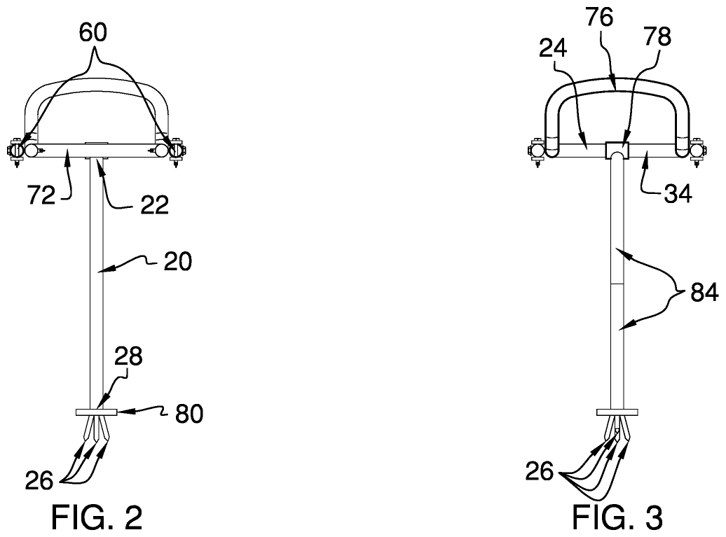

An extension rod 76 is coupled to the second end 24 of the frame 12 and extends transversely from the frame 12. The extension rod 76 is positioned substantially flush to the surface with the frame 12 in the first configuration, as shown in FIG. 6. The extension rod 76 extends arcuately between the second endpoints 36 of the first rods 30, as shown in FIG. 2, and functions to retain the load upon the frame 12 as the frame 12 is transitioned from the first configuration to the second configuration. The device 10 is anticipated to be used in conjunction with cords, straps, and the like (not shown), which would be used to bind the load to the frame 12 before transitioning the frame 12 from the first configuration to the second configuration.

A tube 78 is positioned around the second rod 34 substantially equally distant from the first rods 30. The tube 78 is rotatable relative to the second rod 34. The first terminus 22 of the leg 20 is coupled to the tube 78 and thus the leg 20 is pivotable relative to the frame 12.

A plate 80 is coupled to and positioned between the leg 20 and the plurality of spikes 26. Each spike 26 has a respective angle relative to the plate 80 so that the plurality of spikes 26 comprises spikes 26 that have a variety of angles relative to the plate 80, as shown in FIG. 2. The spikes 26 may be substantially linearly positioned along a longitudinal axis 82 of the plate 80.

In use, the frame 12 is coupled to the cargo rack of the all-terrain vehicle, using the connectors 60, and positioned in the first configuration. The leg 20 is positioned beneath the frame 12 and extends along the surface toward the vehicle 16. The load is positioned on the frame 12 and the extension rod 76. As the vehicle 16 pulls on the first end 14 of the frame 12, the spikes 26 engage the surface to transition the frame 12 from the first configuration to the second configuration. With the frame 12 positioned in the second configuration, the user is positioned to slide the load from the frame 12 to the cargo area 18 of the vehicle 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A ground to vehicle loading device comprising:
a frame configured to be pivotally mountable by a first end to a vehicle adjacent to a cargo area of the vehicle, such that the frame is selectively pivotable from a first configuration wherein the frame extends transversely from the cargo area to a surface upon which the vehicle is positioned, wherein the frame is configured for positioning a load, and a second configuration wherein the frame is substantially horizontal to the surface wherein the frame is configured for transferring the load to the cargo area;
a leg pivotally coupled by a first terminus to the frame proximate to a second end of the frame; and
a plurality of spikes coupled to and extending from a second terminus of the leg wherein the spikes are configured for engaging the surface for transitioning the frame from the first configuration to the second configuration as the vehicle pulls on the first end of the frame;
wherein the frame comprises
a pair of first rods each having a first endpoint configured to be pivotally coupled to the vehicle,
a second rod coupled to and extending between the first rods proximate to second endpoints of the first rods, and
wherein each first rod comprises
a first section, and
a second section pivotally engaged to the first section, such that the first section and the second section are selectively pivotable to a folded configuration wherein the first end of the frame is positioned proximate to the second end of the frame, the second section being selectively fixedly couplable to the first section for fixedly positioning the frame in a planar configuration.

2. (canceled)

3. (canceled)

4. The ground to vehicle loading device of claim 1, further including:
the first section and the second section being partially overlapping, each of the first section and the second section having a pivot hole positioned therethrough such that the pivot holes are aligned, each of the first section and the second section having a locking hole positioned therethrough such that the locking holes are selectively alignable;
a pivot fastener inserted through the pivot holes for pivotally connecting the first section to the second section; and
a locking fastener selectively insertable through the locking holes for fixedly positioning the frame in a planar configuration.

5. The ground to vehicle loading device of claim 1, further including a pair of connectors, each connector being engaged to the first endpoint of a respective first rod and configured for reversibly engaging a bar of a cargo rack of the vehicle for removably and pivotally mounting the frame to the vehicle.

6. The ground to vehicle loading device of claim 5, wherein each connector comprises a pair of tabs, each tab having a connecting hole positioned therethrough such that the connecting holes are positioned for inserting a connecting fastener for pivotally connecting the respective first rod to the bar of the cargo rack.

7. The ground to vehicle loading device of claim 4, further including a third rod coupled to and extending between the second sections for rigidifying the frame, the third rod being positioned between the pivot holes and the locking holes.

8. The ground to vehicle loading device of claim 7, further including a fourth rod coupled to and extending between the second sections for rigidifying the frame, the fourth rod being positioned substantially equally distant from the second rod and the pivot holes.

9. The ground to vehicle loading device of claim 1, further including an extension rod coupled to the second end of the frame and extending transversely from the frame such that the extension rod is positioned substantially flush to the surface with the frame in the first configuration.

10. The ground to vehicle loading device of claim 1, further including an extension rod coupled to the second end of the frame and extending transversely from the frame such that the extension rod is positioned substantially flush to the surface with the frame in the first configuration, the extension rod extending arcuately between the second endpoints of the first rods.

11. The ground to vehicle loading device of claim 1, wherein the leg comprises a plurality of nested sections such that the leg is selectively extensible.

12. The ground to vehicle loading device of claim 1, further including a tube positioned around the second rod substantially equally distant from the first rods, the tube being rotatable relative to the second rod, the first terminus of the leg being coupled to the tube.

13. The ground to vehicle loading device of claim 1, further including a plate coupled to and positioned between the leg and the plurality of spikes, each spike having a respective angle relative to the plate such that the plurality of spikes comprises spikes having a variety of angles relative to the plate.

14. The ground to vehicle loading device of claim 13, further including the spikes being substantially linearly positioned along a longitudinal axis of the plate.

15. A vehicle and ground to vehicle loading device combination comprising:
a vehicle having a cargo area,
a frame selectively pivotally mountable by a first end to the vehicle adjacent to the cargo area, such that the frame is selectively pivotable from a first configuration wherein the frame extends transversely from the cargo area to a surface upon which the vehicle is positioned, wherein the frame is configured for positioning a load, and a second configuration wherein the frame is substantially horizontal to the surface wherein the frame is configured for transferring the load to the cargo area;
a leg pivotally coupled by a first terminus to the frame proximate to a second end of the frame; and
a plurality of spikes coupled to and extending from a second terminus of the leg wherein the spikes are configured for engaging the surface for transitioning the frame from the first configuration to the second configuration as the vehicle pulls on the first end of the frame; and
wherein the frame comprises
a pair of first rods each having a first endpoint configured to be pivotally coupled to the vehicle each first rod comprising a first section pivotally engaged to a second section to the first section, such that the first section and the second section are selectively pivotable to a folded configuration wherein the first end of the frame is positioned proximate to the second end of the frame, the second section being selectively fixedly couplable to the first section for fixedly positioning the frame in a planar configuration,
a second rod coupled to and extending between the first rods proximate to second endpoints of the first rods, and
a tube positioned around the second rod substantially equally distant from the first rods, the tube being rotatable relative to the second rod, the first terminus of the leg being coupled to the tube.

16. (canceled)

17. The vehicle and ground to vehicle loading device combination of claim 15, further including:
the first section and the second section being partially overlapping, each of the first section and the second section having a pivot hole positioned therethrough such that the pivot holes are aligned, each of the first section and the second section having a locking hole positioned therethrough such that the locking holes are selectively alignable;
a pivot fastener inserted through the pivot holes for pivotally connecting the first section to the second section;
a locking fastener selectively insertable through the locking holes for fixedly positioning the frame in a planar configuration;
a third rod coupled to and extending between the second sections for rigidifying the frame, the third rod being positioned between the pivot holes and the locking holes;
a fourth rod coupled to and extending between the second sections for rigidifying the frame, the fourth rod being positioned substantially equally distant from the second rod and the pivot holes; and
a pair of connectors, each connector being engaged to the first endpoint of a respective first rod and configured for reversibly engaging a bar of a cargo rack of the vehicle for removably and pivotally mounting the frame to the vehicle.

18. The vehicle and ground to vehicle loading device combination of claim 15, further including an extension rod coupled to the second end of the frame and extending transversely from the frame such that the extension rod is positioned substantially flush to the surface with the frame in the first configuration.

19. The vehicle and ground to vehicle loading device combination of claim 15, further including:
the leg comprising a plurality of nested sections such that the leg is selectively extensible; and
a plate coupled to and positioned between the leg and the plurality of spikes, each spike having a respective angle relative to the plate such that the plurality of spikes comprises spikes having a variety of angles relative to the plate.

20. A ground to vehicle loading device comprising:
a frame configured to be pivotally mountable by a first end to a vehicle adjacent to a cargo area of the vehicle, such that the frame is selectively pivotable from a first configuration wherein the frame extends transversely from the cargo area to a surface upon which the vehicle is positioned, wherein the frame is configured for positioning a load, and a second configuration wherein the frame is substantially horizontal to the surface wherein the frame is configured for transferring the load to the cargo area, the frame comprising:
a pair of first rods each having a first endpoint configured to be pivotally coupled to the vehicle, each first rod comprising a first section pivotally engaged to a second section, such that the first section and the second section are selectively pivotable to a folded configuration wherein the first end of the frame is positioned proximate to a second end of the frame, the second section being selectively fixedly couplable to the first section for fixedly positioning the frame in a planar configuration,
a pair of connectors, each connector being engaged to the first endpoint of a respective first rod and configured for reversibly engaging a bar of a cargo rack of the vehicle for removably and pivotally mounting the frame to the vehicle, each connector comprising a pair of tabs, each tab having a connecting hole positioned therethrough such that the connecting holes are positioned for inserting a connecting fastener for pivotally connecting the respective first rod to the bar of the cargo rack,
a second rod coupled to and extending between the first rods proximate to second endpoints of the first rods,
a tube positioned around the second rod substantially equally distant from the first rods, the tube being rotatable relative to the second rod,
the first section and the second section being partially overlapping, each of the first section and the second section having a pivot hole positioned therethrough such that the pivot holes are aligned, each of the first section and the second section having a locking hole positioned therethrough such that the locking holes are selectively alignable,
a pivot fastener inserted through the pivot holes for pivotally connecting the first section to the second section,
a locking fastener selectively insertable through the locking holes for fixedly positioning the frame in a planar configuration,
a third rod coupled to and extending between the second sections for rigidifying the frame, the third rod being positioned between the pivot holes and the locking holes,
a fourth rod coupled to and extending between the second sections for rigidifying the frame, the fourth rod being positioned substantially equally distant from the second rod and the pivot holes, and
an extension rod coupled to the second end of the frame and extending transversely from the frame such that the extension rod is positioned substantially flush to the surface with the frame in the first configuration, the extension rod extending arcuately between the second endpoints of the first rods;
a leg pivotally coupled by a first terminus to the frame proximate to the second end of the frame, the leg comprising a plurality of nested sections such that the leg is selectively extensible, the first terminus of the leg being coupled to the tube;
a plurality of spikes coupled to and extending from a second terminus of the leg wherein the spikes are configured for engaging the surface for transitioning the frame from the first configuration to the second configuration as the vehicle pulls on the first end of the frame; and
a plate coupled to and positioned between the leg and the plurality of spikes, each spike having a respective angle relative to the plate such that the plurality of spikes comprises spikes having a variety of angles relative to the plate, the spikes being substantially linearly positioned along a longitudinal axis of the plate.
